(19) United States
(12) Patent Application Publication
(10) Pub. No.: US 2016/0152088 A1
(43) Pub. Date: Jun. 2, 2016

(54) Tire Tread Surface for a Two-Wheeled Vehicle

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Rudy MEGEVAND, Clermont-Ferrand Cedex 9 (FR); Arnaud LARREGAIN, Clermont-Ferrand Cedex 9 (FR)

(21) Appl. No.: 14/901,332

(22) PCT Filed: Jun. 26, 2014
(86) PCT No.: PCT/EP2014/063566

§ 371 Date: Dec. 28, 2015

(30) Foreign Application Priority Data
Jun. 28, 2013 (FR) 1356247

(51) Int. Cl. B60C 11/03

(52) U.S. Cl. CPC B60C 11/0311

(57) ABSTRACT

Tire (1) for two-wheeled vehicle, comprising tread (2) with elastomeric knobs (3) extending radially from base surface (4), and comprising first portion (31) of height h₁ extending radially between base surface (4) and second portion (32) of height h₂. First portion (31) comprises radially exterior face (311) of area S₁, and second portion (32) comprises radially interior face (321) of area S₂. Radially exterior face (311) and radially interior face (321) have noncoincident respective exterior contours and are in contact with one another via a contact area S₁₂. A hand-cutting operation is made simple, quick and repeatable by providing an area S₁₂ at most equal to 0.6 times the area S₁ of the radially exterior face (311).

The subject of the invention is a tire for a two-wheeled vehicle and, more particularly, for a bicycle.

Although not limited to this application, the invention will be described in the case of a tire for a mountain bike, intended to ride over any type of ground, particularly uneven and muddy ground.

It is known that the tires fitted to mountain bikes, particularly for sports use over very uneven courses, have a tread comprising knobs. The knobs are elements of the tread that are raised in relation to a base surface, constituting the tread pattern. The tread and, in particular, the knobs, are generally made of elastomeric material. These knobs, by biting into soft or muddy ground, give the tire grip. They are effective both in providing downhill grip and in providing traction in a climb.

It is also known that a knob may comprise a first portion of height h₁ extending radially between the base surface of the tread and a second portion of height h₂. In other words, a knob may comprise at least two superposed portions in contact with one another via an area of contact. The respectively radially exterior face of the first portion and radially interior face of the second portion generally have different areas, leading to a discontinuity between the first and second portions. The radially exterior face of the first portion usually, although not necessarily, has the larger area. “Radially interior” and “radially exterior” respectively mean “closer, in the radial direction, to the axis of rotation of the tire” and “further, in the radial direction, from the axis of rotation of the tire” in which the radial direction denotes the direction perpendicular to the axis of rotation of the tire. The axial and circumferential directions denote respectively directions parallel to the axis of rotation of the tire and tangential to the running circumference of the tire.

A common practice of well-informed users of mounting bikes of the “downhill and enduro” type is to cut the knobs, which means to say to decrease the height thereof by partially cutting them using a cutting tool such as shears or a cutter. The purpose of this exercise is to alter the height and shape of the knobs to make the tread pattern better suited to the terrain encountered. Thus, a mud tire, initially comprising knobs of a given height, can be converted, after the cutting of the knobs, into a tire that can be used on uneven ground mixed with non-muddy ground.

The cutting, which is generally performed by hand, is a delicate operation dependent on the skill of the operator. It is therefore an operation that is difficult to perform repeatably for each knob concerned and that generally results in nonuniformity of the tire tread pattern. This may lead to problems with performance and, in particular, to problems of vibration and therefore comfort of the tire. In addition, cutting the knobs too low may lead to less effective braking and to problems with road holding or stability in corners or a cross slope.

The inventors set themselves the objective of designing tire tread knobs for a tire of a two-wheeled vehicle for which a hand-cutting operation is simple, quick and repeatable, so as to obtain a uniform tread pattern that optimizes tire performance with respect to the terrain once the cutting operation has been performed.

This objective has been achieved by a tire for a two-wheeled vehicle, comprising:

a tread made of elastomeric material, intended to come into contact with the ground, comprising knobs made of elastomeric material,
the knobs, which are intended to bite into soft ground, extending radially from a base surface,
at least one knob comprising a first portion of height h₁ extending radially between the base surface and a second portion of height h₂,
the first portion comprising a radially exterior face of area S₁, and the second portion comprising a radially interior face of area S₂,
the radially exterior face of the first portion and the radially interior face of the second portion having noncoincident respective exterior contours and being in contact with one another via a contact area,
the area of contact between the radially exterior face of the first portion and the radially interior face of the second portion being at most equal to 0.6 times the area of the radially exterior face of the first portion.

According to the invention, in the case of knobs comprising a first portion of height h₁ extending radially between the base surface and a second portion of height h₂ which are such that the radially exterior face of the first portion and the radially interior face of the second portion have noncoincident respective exterior contours and are in contact with one another via an area of contact, the area of contact must not be too great in comparison with the area of the radially exterior face of the first portion.

With the radially exterior face of the first portion and the radially interior face of the second portion having noncoincident respective exterior contours, the free area of the radially exterior face of the first portion, which means to say the area that is the difference between the area of the radially exterior face of the first portion and the area of contact, guarantees, upon hand cutting using a bladed cutting tool of the cutter or shear type, that the blade of the cutting tool rests firmly against the free area of the radially exterior face of the first portion, in a substantially radial direction. The free area of the radially exterior face of the first portion is the portion of area that is not in contact with the radially interior face of the second portion. A substantially radial direction means a direction perpendicular to the axis of rotation of the tire or forming an angle of at most equal to 45° with the radial direction. Thus, during cutting, the blade is guided in this substantially radial direction, and this contributes to the quality of the cut.

In addition, the difference between the area of the radially exterior face of the first portion and the area of contact, which means to say the free area of the radially exterior face of the first portion, constitutes a visual reference for the operator for positioning the blade of his cutting tool.

The inventors have demonstrated that the area of contact needs ideally to be at most equal to 0.6 times the area of the radially exterior face of the first portion, which means to say that the free area intended for the blade to rest against needs to be at least equal to 0.4 times the area of the radially exterior face of the first portion.

Even though the total area of the radially exterior face of the first portion is usually greater than the total area of the radially interior face of the second portion, it is not impossible for the total area of the radially exterior face of the first portion to be less than the total area of the radially interior face of the second portion.

According to a first preferred embodiment, the area of contact between the radially exterior face of the first portion and the radially interior face of the second portion is equal to the area of the radially interior face of the second portion. This corresponds to the most commonplace scenario in which the total area of the radially exterior face of the first portion is greater than the total area of the radially interior face of the second portion. In other words, the second portion rests enly against the first portion. This configuration corresponds to the conventional mechanical operation in which the narrower second portion is first to bite into the soft ground before the wider second portion, thus allowing the knob to bite progressively into the soft ground.

According to a second preferred embodiment, the height of the second portion is at least equal to 0.25 times the height of the first portion. A second-portion height that is sufficiently great in comparison with a height of a first portion guarantees that the blade of the cutting tool will rest firmly in the axial direction, parallel to the axis of rotation of the tire. Thus, upon cutting, the blade is guided in the axial direction, likewise contributing to the quality of the cut.

Advantageously, the area of contact between the radially exterior face of the first portion and the radially interior face of the second portion is at least equal to 0.3 times the area of the radially exterior face of the first portion, which means to say that the free area intended for the blade to rest against needs to be at most equal to 0.7 times the area of the radially exterior face of the first portion. An area of contact that is sufficiently large in comparison with the area of the radially exterior face of the first portion limits the difference in flexural rigidities between the first and second portions. A second portion that is sufficiently rigid in comparison with the first portion may thus effectively contribute to the traction and braking forces of the knob and is better able to withstand wear and chunking.

Advantageously also, the difference between the area of the radially exterior face of the first portion and the contact area is at least equal to 25 mm² This minimum value for the difference between the area of the radially exterior face of the first portion and the area of contact, namely the free area of the radially exterior face of the first portion, allows the knob to be cut under good conditions, by providing a minimal area against which the blade of the cutting tool can rest.

It is also advantageous for the height of the second portion to be at most equal to 0.25 times the height of the first portion. A second-portion height that is not too great in comparison with a height of the first portion limits the difference in flexural rigidities between the first and second portions. A second portion that is sufficiently rigid in comparison with the first portion may thus effectively contribute to the traction and braking forces of the knob and is better able to withstand wear and chunking.

From a geometric standpoint, the first and second portions of a knob may respectively be inscribed inside first and second cylinders having respective axes of revolution. According to one particular embodiment, the respective axes of revolution of the first and second cylinders are disconnected. This means that the first and second portions of the knob are axially offset, which means to say that the respectively radially exterior face of the first portion and radially interior face of the second portion are not centred relative to one another. This may be the configuration of a knob at the edge of a tread for which the axially exterior face of the second portion is positioned in the continuation of the axially exterior face of the first portion, at the edge of the tread, so as to avoid any discontinuity that is potentially unfavourable towards wear.

According to one preferred embodiment, the first and second portions are hexahedra respectively having four lateral faces substantially perpendicular to the base surface. These are the flat-faced volumetric shapes frequently encountered in the knobs of mounting bike tires.

According to an alternative of the previous preferred embodiment, at least one lateral face of the hexahedron constituting the first portion forms, with at least one lateral face of the hexahedron constituting the second portion, a non-zero angle. This implies that the second portion is rotationally offset from the first portion, something that is characteristic of what is known as a “twisted” knob. Such a “twisted” type of knob makes it easier to clear mud when this knob leaves the contact patch.

Finally it is advantageous for the radially exterior face of the first portion to form an angle with respect to the base surface in the circumferential direction. The result of this is that the contact surface is inclined, in the circumferential direction, either in the direction of running or in the opposite direction to the direction of running of the tire, which improves the braking or traction of the knob. Moreover, an inclined contact surface is easy to cut.

The features and other advantages of the invention will be better understood with the aid of the attached schematic figures which are not drawn to scale:

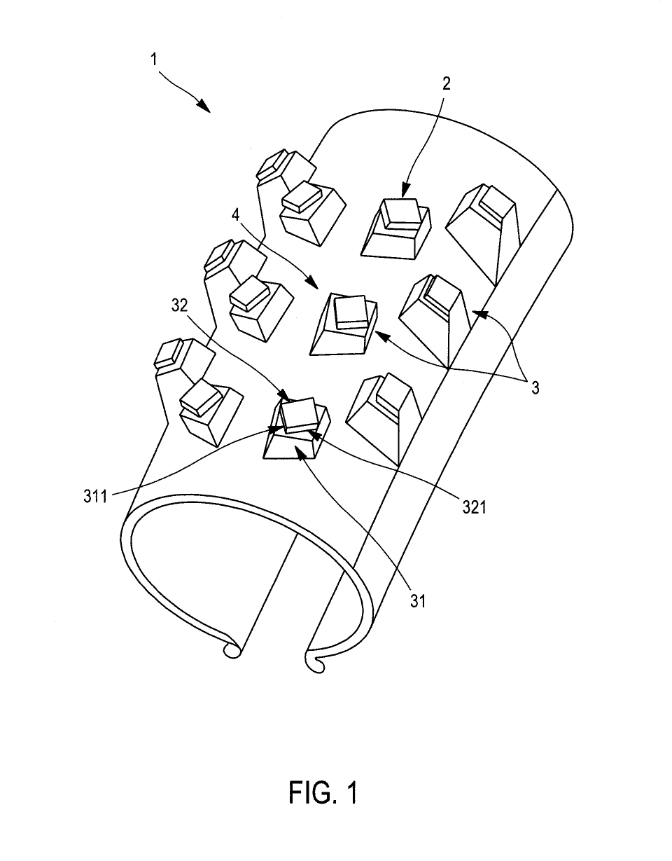

FIG. 1: is a three-dimensional cross section through a mounting bike tire comprising a tread with knobs,

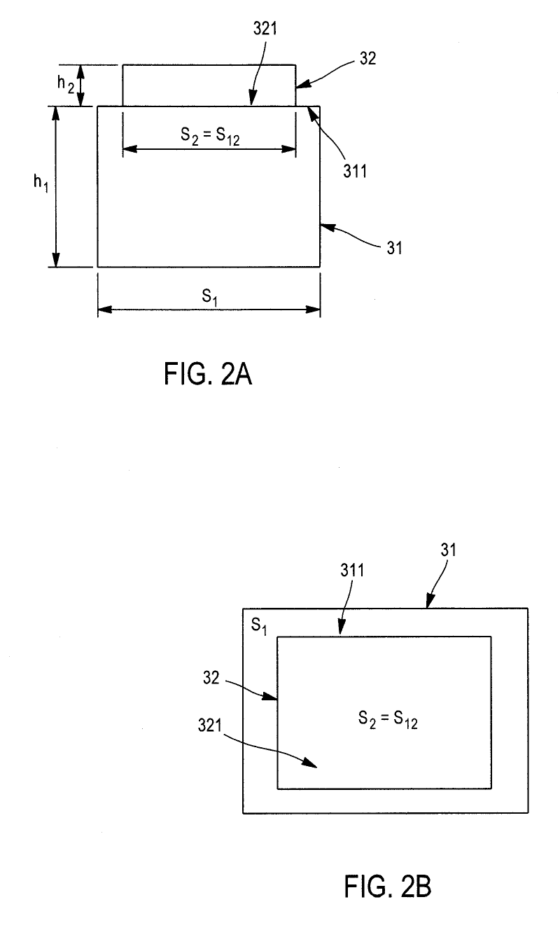

FIGS. 2A and 2B: are a side view and a view from above of a knob,

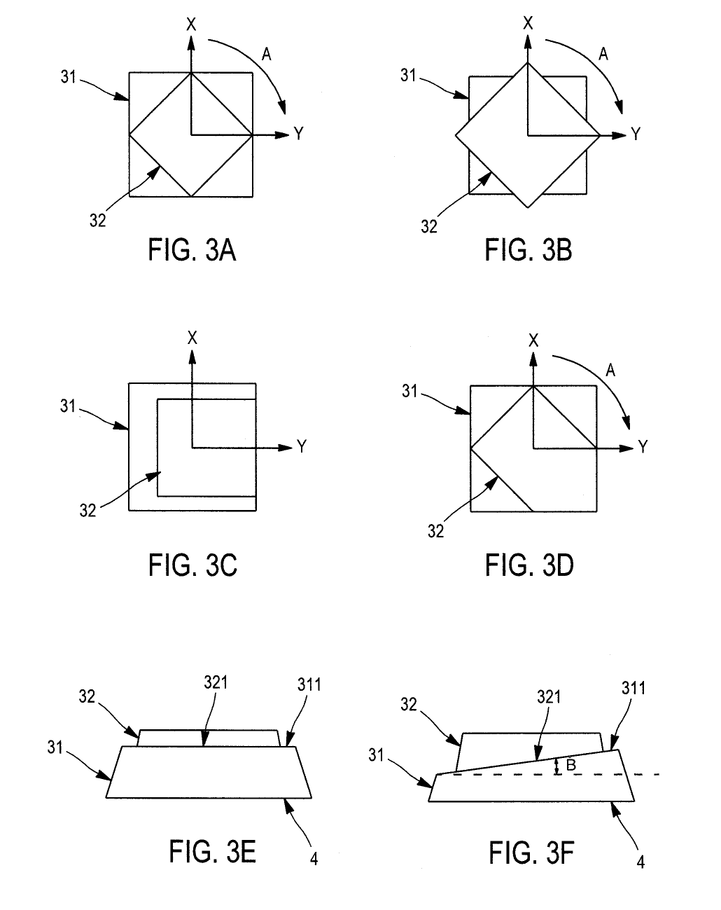

FIGS. 3A to 3F: are views of various embodiments of knob.

FIG. 1 shows a mounting bike tire 1 comprising a tread 2 comprising knobs 3 made of elastomeric material. The knobs 3 extend radially from a base surface 4. Each knob 3 comprises a first portion 31 extending radially between the base surface 4 and a second portion 32. The first portion 31 comprises a radially exterior face 311 and the second portion 32 comprises a radially interior face 321.

FIGS. 2A and 2B respectively are a side view and a view from above of a knob 3, consisting of a first portion 31 of height h₁ having a radially exterior face 311 of area S₁, and a second portion 32 of height h₂ having a radially interior face 321 of area S₂. The radially exterior face 311 of the first portion 31 and the radially interior face 321 of the second portion 32 are in contact with one another via an area of contact S₁₂. In the preferred embodiment depicted, the area S₂ of the radially interior face 321 of the second portion 32 is equal to the area of contact S₁₂, which means that the second portion 32 rests fully against the first portion 31.

FIGS. 3A to 3F are views of various embodiments of knob.

FIG. 3A is a view from above of what is referred to as a “twisted” knob in which the hexagonal second portion 32 is rotationally offset, about a radial axis Z (not depicted) perpendicular to the plane XY, by an angle A with respect to the hexagonal first portion 31.

FIG. 3B is a view from above of what is referred to as a “twisted” knob in which the hexagonal second portion 32 is offset rotationally by an angle A with respect to the hexagonal first portion 31 and in which the area of the radially interior face of the second portion 32 is greater than the area of the radially exterior face of the first portion 31. In other words, in this instance, the second portion 32 protrudes beyond the first portion 31.

FIG. 3C is a view from above of a knob in which the hexagonal second portion 32 is axially offset, in the axial direction Y, from the hexagonal first portion 31 so that the first and second portions are aligned at a lateral face.

FIG. 3D is a view from above of what is referred to as a “twisted” knob in which the hexagonal second portion 32 is rotationally offset by an angle A with respect to the hexagonal first portion 31 and in which the first and second portions are at least partially aligned along two lateral faces.

FIG. 3E is a side view of a knob 3 extending from the base surface 4 radially outwards and comprising a first portion 31 having a radially exterior face 311 and a second portion 32 having a radially interior face 321. The lateral faces of the first and second portions (31, 32) are substantially radial, whereas the area of contact is parallel to the base surface 4.

FIG. 3F differs from FIG. 3E in that the area of contact between the first and second portions (31, 32) forms an angle B with respect to the base surface 4.

The invention has been developed more particularly for a tire of size 27.5×2.25 intended to be fitted to a mounting bike, for which the tread is of the kind depicted in FIG. 1. Such a tread comprises a first type of knob in the middle of the tread and a second type of knob at the edges of the tread.

The knobs of the first type are “twisted” knobs of hexagonal shape, as depicted in FIG. 3A. A knob of the first type comprises a first portion of height 5 mm, having a radially exterior face of area 112 mm² and a second portion of height 2 mm having a radially interior face of area 45 mm² equal to the area of contact. As a result, the area of contact is equal to 0.4 times the area of the radially exterior face of the first portion and therefore at most equal to 0.6 times the area of the radially exterior face of the first portion.

The knobs of the second type are “offset” knobs of hexagonal shape, as depicted in FIG. 3C. A knob of the second type comprises a first portion of height 6.5 mm having a radially exterior face of area 67 mm² and a second portion of height 2 mm having a radially interior face of area 35 mm² equal to the area of contact. As a result, the area of contact is equal to 0.52 times the area of the radially exterior face of the first portion and therefore at most equal to 0.6 times the area of the radially exterior face of the first portion.

The invention may be applied to all the knobs of the tread or just the knobs of one or a number of zones of the tread, for example the middle of the tread. Although described in the case of a bicycle tire, the invention may also be applied to any tire that has knobs, such as, for example, a tire for a scramble bike.

1. A tire for a two-wheeled vehicle, comprising:
a tread made of elastomeric material, intended to come into contact with the ground, comprising knobs made of elastomeric material;
the knobs, which are intended to bite into soft ground, extending radially from a base surface;
at least one knob comprising a first portion of height h₁ extending radially between the base surface and a second portion of height h₂;
the first portion comprising a radially exterior face of area S₁, and the second portion comprising a radially interior face of area S₂;
the radially exterior face of the first portion and the radially interior face of the second portion having noncoincident respective exterior contours and being in contact with one another via a contact area S₁₂; and
wherein the area S₁₂ of contact between the radially exterior face of the first portion and the radially interior face of the second portion is at most equal to 0.6 times the area S₁ of the radially exterior face of the first portion.

2. The tire according to claim 1, in wherein the area S₁₂ of contact between the radially exterior face of the first portion and the radially interior face of the second portion is equal to the area S₂ of the radially interior face of the second portion.

3. The tire according to claim 1, wherein the height h₂ of the second portion is at least equal to 0.25 times the height h₁ of the first portion.

4. The tire according to claim 1, wherein the area S₁₂ of contact between the radially exterior face of the first portion and the radially interior face of the second portion is at least equal to 0.3 times the area S₁ of the radially exterior face of the first portion.

5. The tire according to claim 1, wherein the difference between the area S₁ of the radially exterior face of the first portion and the contact area S₁₂ is at least equal to 25 mm².

6. The tire according to claim 1, wherein the height h₂ of the second portion is at most equal to 0.25 times the height h₁ of the first portion.

7. The tire according to claim 1, the first and second portions being respectively inscribed inside first and second cylinders having respective axes of revolution, wherein the respective axes of revolution (D₁, D₂) of the first and second cylinders are not connected.

8. The tire according to claim 1, wherein the first and second portions are hexahedra respectively having 4 lateral faces substantially perpendicular to the base surface.

9. The tire according to claim 8, wherein at least one lateral face of the hexahedron constituting the first portion forms, with at least one lateral face of the hexahedron constituting the second portion, a non-zero angle.

10. The tire according to claim 1, wherein the radially exterior face of the first portion forms an angle with respect to the base surface in the circumferential direction of the tire.
